(19) United States
(12) Patent Application Publication
(10) Pub. No.: US 2023/0367679 A1
(43) Pub. Date: Nov. 16, 2023

(54) USER EQUIPMENT FOR FLASHBACK OF DATABASE AND OPERATING METHOD THEREFOR

(71) Applicant: GACHIDATA, Seoul (KR)

(72) Inventor: Jeong Ho SON, Seoul (KR)

(21) Appl. No.: 18/196,899

(22) Filed: May 12, 2023

(30) Foreign Application Priority Data
May 16, 2022 (KR) 10-2022-0059614

(51) Int. Cl. G06F 11/14; G06F 16/23; G06F 16/22

(52) U.S. Cl. CPC G06F 11/1456; G06F 16/2358; G06F 16/2282; G06F 2201/84

(57) ABSTRACT

Disclosed are a user equipment for flashback of a database and an operating method therefor, and more particularly, a user equipment for flashback of a database and an operating method therefor, which minimize, when storing log information for a data change of a database, data included in the log information and store the minimized data in the database, provide a snapshot acquired by recovering the database at a recovery time point according to a request for flashback for the database based on the log information, and support the database to be easily recovered at a time point desired by a user while reducing a processing load for the database.

### CROSS-REFERENCE TO RELATED APPLICATIONS

This application claims the priority of Korean Patent Application No. 10-2022-0059614 filed on May 16, 2022, in the Korean Intellectual Property Office, the disclosure of which is incorporated herein by reference.

### BACKGROUND OF THE INVENTION

### Field of the Invention

The present disclosure relates to a user equipment for flashback of a database and an operating method therefor, and more particularly, to a user equipment for flashback of a database and an operating method therefor, which minimize, when storing log information for a data change of a database, data included in the log information and store the minimized data in the database, provide a snapshot acquired by recovering the database at a recovery time point according to a request for flashback for the database based on the log information, and support the database to be easily recovered at a time point desired by a user while reducing a processing load for the database.

### Description of the Related Art

In modern times, various information is collected and utilized to obtain information valid for individuals and companies, and various IT systems are being used for this. A core of an IT system to deal with valid data is a database and a database management system (DBMS) technology, and each company's DBMS stores and manages various and vast materials including contents and products, customers, transactions and marketing, supply chains, personnel, finance, personalized information, etc.

Database administrators of the company collect and store, and manage many data required to manage vast information, protect the data, and back up the database regularly to stabilize the database. To perform such a task, a policy for a backup frequency and a backup target is established, and a space of a disk for the task is secured. A backup task targets complete images of the database as needed, or targets multiple incremental or differential data. Such backup data can be used properly if a problem occurs in a database such as disk failure and loss of data files.

However, in the situation where the user's mistake or the wrong transaction processing requires the process of inquiring or returning the data from a specific point of view, the above backup method is not appropriate. Because the database is a normal state, the backup and recovery methods that take into account abnormal situations in consideration of the database are unnecessarily consuming excessive resources and time, and a cause and a solving means of the problem are not in harmony.

At present, the database is normal, but there are several methods to restore the user's mistake or wrong transaction processing. A typical method is to collect UNDO records so that data from a specific point of view can be searched, and the collection of the UNDO records collects and manages all changes in the database, so to maintain the UNDO record for a long time, a storage space like many disks should be used, and many records should be processed even if only a specific table of the relational database is required. In addition, since the UNDO record is originally managed transaction rollback processing, a large amount of UNDO information should be recorded and managed according to such characteristics. On the other hand, with respect to a task that recovers data at a specific time point through incomplete recovery, an incomplete recovery task for an entire database is performed to return a normal database to a previous time point, and as a result, a lot of disks are used and a lot of time is required, and there is also a case where recovery is impossible due to such a constraint. The methods may show a limitation that a time point requiring a snapshot can be actually utilized only at a past time point close to a present time point due to difficulties in maintenance of a backup copy and management of a large amount of UNDO records.

Meanwhile, a recent database effectively processes vast data in terms of a scale and a function thereof, and is developed so that a lot of users can frequently approach and use the DBMS, and this requires vast log information generation and storage, and rapid processing therefor. When additional processing such as compression is introduced to process a lot of data, more execution time is required, and a time when compression is released is additionally required even to search for a required log. In an opposite case in which the compression is not performed, the size of the log increases, and as a result, a disk I/O is generated, and the size of a required storage space increases, and a disk management load for processing this increases. According to a trend in which when data is continuously input, log data linearly increases, so a scale of a current database system increases, a case where up to hundreds of tera bytes should be managed often occurs. Consequently, rapid increase of the log data increases storage cost and management cost, and extremely lowers a possibility and efficiency of search of previous data.

### SUMMARY OF THE INVENTION

In order to improve the above problem, the present disclosure has been made in an effort to decompose data managed and duplicated jointly with metadata such as a change time, a primary key of a relational database, a row identifier of a relational DBMS with respect to data inserted into, updated to, and deleted from the relational database by the unit of a column to prevent the corresponding data from being stored, and as a result, a log amount is significantly reduced to reduce a disk I/O burden and significantly reduce a storage space and a processing time of a DBMS, and an SQL for flashback is generated based on log data minimally stored at a flashback request for the database at a specific time point to generate and provide a snapshot without data loss at the corresponding specific time point from the database, thereby supporting recovery without a time constraint to be enabled.

According to an exemplary embodiment of the present disclosure, a user equipment which interlocks with a DBMS may include: a data processing unit storing SQL data for storing, when the data stored in the DBMS is changed, the data in the DBMS, and generating, in the DBMS, column information on an interested column of which set value is changed among one or more columns constituting a change target table which stores the changed data, and log information including identifier and instruction types corresponding to the changed data and a change time, and storing the log information in the DBMS, and transmitting the SQL data to the DBMS; a log information management unit collecting log information stored in a log DB of the DBMS, and partitioning and managing the collected log information to different log tables by the unit of a predetermined period; and a data inquiry unit collecting, when receiving a flashback request for recovering the change target table to a specific time point, from one or more log tables corresponding to an interested period between the specific time point and a current time point, generating one or more recovery information based on the collected log information, and then generating single recovery SQL data based on the one or more recovery information, and transmitting the single recovery SQL data to the DBMS to allow the DBMS to generate a snapshot corresponding to the specific time point based on the single recovery SQL data.

As an example related to the present disclosure, the data processing unit generates SQL data for storing, in the log DB of the DBMS, log information selectively including the column information including a column item for each of one or more interested columns among one or more columns constituting the change target table and a set value before a change according to the instruction type, and including an identifier allocated by the DBMS corresponding to the changed data, and an instruction type and a change time used for the change of the data in the log DB of the DBMS, and transmits the generated SQL data to the DBMS.

As an example related to the present disclosure, when the instruction type according to the data change for the change target table is data add, the data processing unit generates SQL data for generating log information including the identifier, the instruction type, and the change time, and transmits the generated SQL data to the DBMS.

As an example related to the present disclosure, the data processing unit generates SQL data for generating log information from which set values corresponding to the remaining columns other than the interested column among the column-specific set values corresponding to the changed data are deleted, and transmits the SQL data to the DBMS.

As an example related to the present disclosure, the log information management unit deletes a log table corresponding to log information of which storage cycle arrives among the plurality of log tables according to a storage cycle of the log information predetermined according to a user input.

As an example related to the present disclosure, the data inquiry unit generates recovery information for adding or updating a set value for each interested column corresponding to the log information, or deleting a set value of the change target table corresponding to the identifier with an instruction type predetermined to be opposite to the instruction type according to the log information for each of the collected log information, and then generates the single recovery SQL data based on the recovery information generated for each collected log information.

As an example related to the present disclosure, the instruction type includes data addition, data delete, and data update, and by the data inquiry unit, the data delete is set as an instruction type opposite to the data insert, the data insert is set as an instruction type opposite to the data delete, and the data update is set as an instruction type opposite to the data update.

As an example related to the present disclosure, the data inquiry unit identifies the instruction type included in the log information for each collected log information, generates recovery information including an identifier according to log information for each log information in which the identified instruction type is the data addition an instruction type for deleting a column-specific set value matched with the corresponding identifier from the change target table confirms an interested column for each of one or more log information in which the identified instruction type is the data update and collects only set values of interested columns included in log information most adjacent to the specific time point for each confirmed interested column to generate one recovery information corresponding to one or more log information, generates recovery information in which the interested-column set value according to the log information is added to the change target table for each log information in which the identified instruction type is the data delete, and generates the single recovery SQL data based on one or more recovery information generated to correspond to the one or more collected log information.

According to an exemplary embodiment of the present disclosure, an operating method for flashback of a database of a user equipment which interlocks with a DBMS may include: generating SQL data for storing, when the data stored in the DBMS is changed, the data in the DBMS, and generating, by the DBMS, column information on an interested column of which set value is changed among one or more columns constituting a change target table which stores the changed data, and log information including identifier and instruction types corresponding to the changed data and a change time, and storing the log information in the DBMS, and transmitting the SQL data to the DBMS; collecting log information stored in a log DB of the DBMS, and partitioning and managing the collected log information to different log tables by the unit of a predetermined period by a user; and collecting, when receiving a flashback request for recovering the change target table to a specific time point, from one or more log tables corresponding to an interested period between the specific time point and a current time point, generating one or more recovery information based on the collected log information, and then generating single recovery SQL data based on the one or more recovery information, and transmitting the single recovery SQL data to the DBMS to allow the DBMS to generate a snapshot corresponding to the specific time point based on the single recovery SQL data.

As an example related to the present disclosure, the generating of the snapshot further includes generating recovery information for adding or updating a set value for each interested column corresponding to the log information, or deleting a set value of the change target table corresponding to the identifier with an instruction type predetermined to be opposite to the instruction type according to the log information for each of the collected log information, and then generating the single recovery SQL data based on the recovery information generated for each collected log information.

According to the present disclosure, a UNDO record at each time point for recovering to a specific time point for a database is not kept, and data is decomposed at a column level and log information from which duplication of data is removed is stored in a DBMS, so in an environment in which a lot of data change histories are generated and a database requiring searching data at a previous time point is required, a minimum change history is managed and stored and a disk space required for storing a changed record can be significantly reduced, and as a result, cost can be reduced and a processing speed can be also improved, and recovered information is easily generated based on one or more log information collected between a specific time point when a user desires flashback and a current time point to support the recovery to be made based thereon and support one or more recovered information to be enabled to be processed with one SQL datum, thereby significantly reducing a processing load of a DBMS and simultaneously significantly increasing processing efficiency of the DBMS for database recovery.

Further, according to the present disclosure, metadata such as an identifier is used while the data change history is managed to reduce a size of execution history information, and a log information amount for a complete snapshot is significantly reduced without information loss while not influencing a processing speed.

Moreover, according to the present disclosure, a change history is managed by the unit of a specific table, and a long-term change history is supported to be managed from a desired time point through partition view based partition management for the log information.

Besides, according to the present disclosure, when the change history, and the snapshot at the specific time point are required, the change history and the snapshot are generated and provided by using the change history, and a time according to unnecessary data processing is reduced through condition search and table-specific search so that the user may inquire only required data in this process, and optimized data is provided to the user.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram of a service providing system for flashback of a database according to an exemplary embodiment of the present disclosure;

FIG. 2 is a configuration diagram of a user equipment for flashback of the database according to an exemplary embodiment of the present disclosure;

FIG. 3 is an operation exemplary diagram of the user equipment for flashback of the database according to an exemplary embodiment of the present disclosure;

FIGS. 4 to 7 are an operation flowchart and an exemplary diagram for log information generation of the user equipment for flashback of the database according to an exemplary embodiment of the present disclosure;

FIG. 8 is an operation exemplary diagram of partition view management of the user equipment for flashback of the database according to an exemplary embodiment of the present disclosure; and

FIGS. 9 to 11 are an exemplary diagram and a flowchart for a flashback operation of the user equipment for flashback of the database according to an exemplary embodiment of the present disclosure.

### DETAILED DESCRIPTION OF THE PREFERRED EMBODIMENT

Hereinafter, detailed exemplary embodiments of the present disclosure will be described with reference to the drawings.

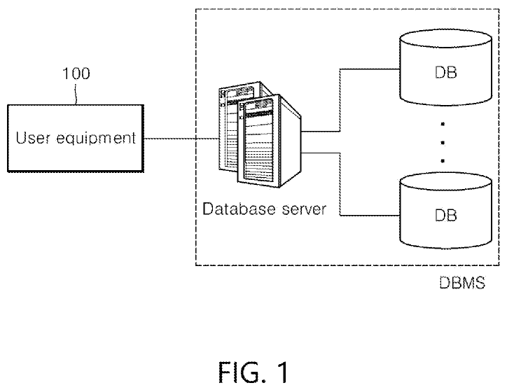

FIG. 1 is a configuration diagram of a service providing system for flashback of a database according to an exemplary embodiment of the present disclosure.

As illustrated, the service providing system according to an exemplary embodiment of the present disclosure may be configured to include a database management system (hereinafter, referred to as DBMS) constituted by a database server including one or more databases and a user equipment 100 which communicates with the DBMS through a communication network.

Hereinafter, the described DBMS may mean a database server in which an application program for management of the database is installed, and the database server stores the database included in the database server, and supports a structured query language (SQL) and searches the database based on SQL data generated based on the SQL from the user equipment 100 to process data according to an instruction type according to the SQL data.

Further, the communication network described in the present disclosure may include a wired/wireless communication network, and an example of the wireless communication network may include Wireless LAN (WLAN), Digital Living Network Alliance (DLNA), Wireless Broadband (Wibro), World Interoperability for Microwave Access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA), HSDPA (High Speed Downlink Packet Access (WCDMA), High Speed Uplink Packet Access (HSUPA), IEEE 802.16, Long Term Evolution (LTE), Long Term Evolution-Advanced (LTE-A), Wireless Mobile Broadband Service (WMBS), 5G mobile communication service, Bluetooth, Long Range (LoRa), Radio Frequency Identification (RFID), Infrared Data Association (IrDA), Ultra Wideband (UWB), ZigBee, Near Field Communication (NFC), Ultra Sound Communication (USC), Visible Light Communication (VLC), Wi-Fi, Wi-Fi Direct, etc. In addition, the wired communication network may include wired local area network (LAN), wired wide area network (WAN), power line communication (PLC), USB communication, Ethernet, serial communication, optical/coaxial cable, and the like.

Further, the user equipment 100 may include various terminals including a smart phone, a portable terminal, a mobile terminal, a personal digital assistant (PDA), a personal computer, a laptop computer, a slate PC, a tablet PC, an ultrabook, etc., which have a communication function.

Further, the user equipment 100 accesses the DBMS to generate SQL data in which an instruction type for searching the data stored in the DBMS, adding data, updating data, or deleting data are set, and transmit the generated SQL data to the DBMS, and the DBMS may process data stored in the database according to the SQL data.

Further, the user equipment 100 may also be constituted by a server which interlocks with the DBMS, and in this case, the user equipment communicates with a terminal possessed by a user through the communication network to receive input information according to a user input from the corresponding terminal or provide various information to the terminal, and through this, the exemplary embodiments described in the present disclosure may be implemented.

When the user requests flashback to recover the database with data (or a data state) at a specific time point due to a mistake or wrong transaction processing of the user in the data processing process of the DBMS, the data at the specific time point is supported to be inquired by collecting the UNDO record in the DBMS in the related art, but since the UNDO record based database recovery scheme should collect and manage all changed information of the database as described above, a high-capacity data storage space is required, and a storage space which may be allocated to the UNDO record is limited, so a recoverable period is also significantly limited.

Further, when a database recovery scheme using existing backup data is used for recovering the data for simple data inquiry, the database itself is recovered with the backup data, so a significant time is required, and a serious problem in that an error occurs in the DBMS in the recovery process may also be caused.

As described above, in the present disclosure, log information for data changed when the data stored in the DBMS is changed is generated, and the log information is generated only by metadata collected for the changed data to store log information having a minimum size in the DBMS, and one or more recovered information is generated based on log information collected between a specific time point at which the user intends to recover the database and a current time point, and then single SQL data for a recovery purpose for recovering the data stored in the DBMS to the data at the specific time point to support the database to be simply and easily recovered with the data at the specific time point based on the single SQL data in the DBMS to provide a long-term recoverable time point while minimizing a storage capacity of log data required for recovering the database, and efficiency may be increased by minimizing a load required in the DBMS in the recovery process, and this will be described below in detail with reference to the drawings.

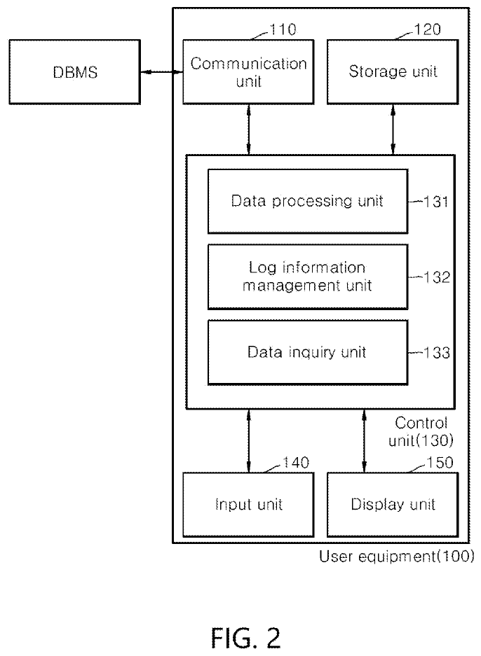

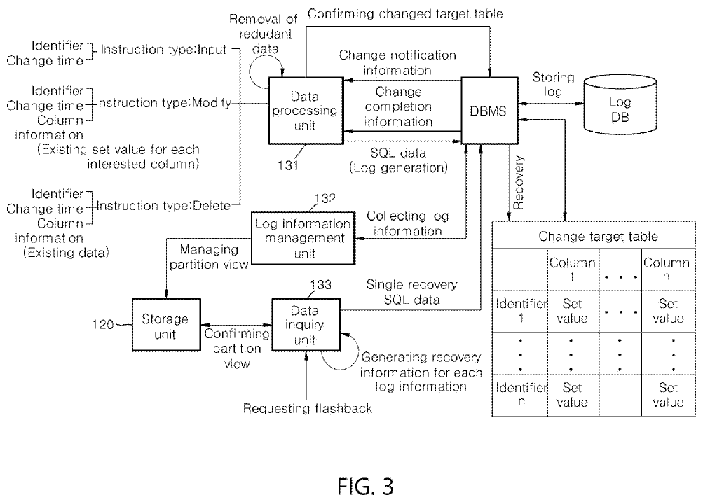

FIG. 2 is a configuration diagram of a user equipment 100 for flashback of the database according to an exemplary embodiment of the present disclosure and FIG. 3 is an operation exemplary diagram of the user equipment 100 for flashback of the database according to an exemplary embodiment of the present disclosure.

As illustrated, the user equipment 100 may be configured to include a communication unit 110, a storage unit 120, a display unit 150, an input unity 140, and a control unit 130.

In this case, the communication unit 110 may communicate with the DBMS through the communication network.

Further, the storage unit 120 may store various information, and the storage unit 120 may be configured in various types including a hard disk drive (HDD), a solid state drive (SSD), etc.

Further, the display unit 150 may display various information, and the input unit 140 may receive the user input. Further, the control unit 130 may perform an overall control function of the user equipment 100, and the control unit 130 may include a RAM, a ROM, a CPU, a GPU, and a bus, and the RAM, the ROM, the CPU, and the GPU may be connected to each other through the bus.

Further, the communication unit 110 and the storage unit 120 may also be configured to be included in the control unit 130.

Further, some of a plurality of components constituting the user equipment 100 may also be omitted, of course.

In this case, the control unit and at least one of various components constituting the control unit 130 may communicate with the DBMS through the communication unit 110, and hereinafter, a communication configuration through the communication unit 110 will be omitted.

As illustrated, the control unit 130 may be configured to include a data processing unit 131, a log information management unit 132, and a data inquiry unit 133.

In this case, the data processing unit 131, the log information management unit 132, and the data inquiry unit 133 may also be configured by one application executed by the control unit 130.

First, the data processing unit 131 may store SQL data for storing, when the data stored in the DBMS (or the database) is changed, the data in the DBMS, and generating, in the DBMS, column information on an interested column of which set value is changed among one or more columns constituting a change target table which stores the changed data, and log information including identifier and instruction types corresponding to the changed data and a change time, and storing the log information in the DBMS, and transmit the SQL data to the DBMS.

In this case, the set value may mean a data value corresponding to the column.

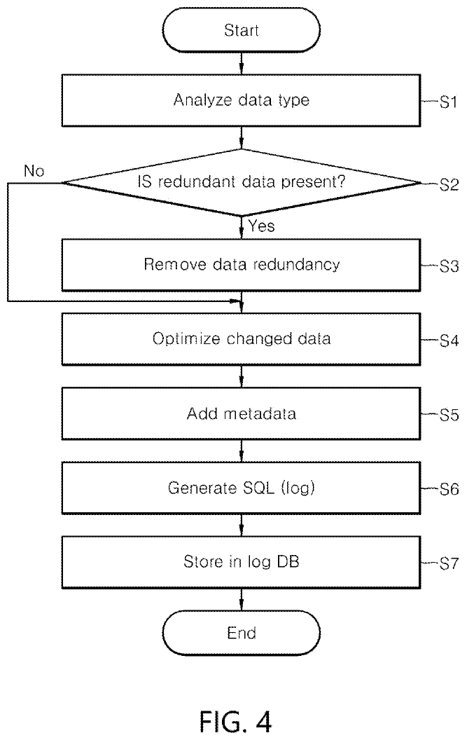

When an example therefor is described with reference to the flowchart of FIG. 4, if the DBMS receives SQL based data processing request information for changing the data stored in the DBMS, the DBMS may generate change notification information and transmit the generated change notification information to the user equipment 100 before performing the SQL according to the data processing request information.

In this case, the change notification information may be configured to include the data processing request information.

As a result, the data processing unit 131 may confirm a change target table which corresponds to the change notification information by accessing the DBMS when receiving the change notification information.

Further, the data processing unit 131 may identify the SQL based instruction type according to the data processing request information by analyzing (or parsing) the data processing request information and identify at least one of a row according to the data processing request information and column-specific column information to be changed, which corresponds to the data processing request information when removal of duplicated data is required according to the instruction type (S1).

In this case, the row may be constituted by a unique identifier (e.g., row ID (RID), when data is added to the change target table granted (allocated) to the added data, and the DBMS may allocate the identifier to the added data, and then match the allocated identifier with the added data, and store the data with the identifier in the change target table.

Further, the column information included in the data processing request information may include a column item and a change value (new set value) corresponding to a change target column which is a data change target.

Further, the data processing unit 131 may confirm the change target table, which corresponds to the change notification information by accessing the DBMS when receiving the change notification information, and confirm existing data which is data before performing the SQL according to the data processing request information by confirming the column and the identifier corresponding to the change notification information in the change target table.

That is, the data processing unit 131 may confirm the existing data which is the previous data before performing the change according to the data processing request information, while being the change target data according to the data processing request information based on the change notification information.

Further, the data processing unit 131 may receive the existing data from the DBMS, and then match the existing data with the change notification information, and temporarily store the existing data matched with the change notification information in the storage unit 120.

In this case, the data processing unit 131 may not confirm the existing data when the instruction type according to the data processing request information is ‘data addition (or input)’.

Further, the data processing unit 131 may receive change completion information from the DBMS when changing the existing data of the DBMS is completed according to the data processing request information.

Further, the data processing unit 131 may access the DBMS based on the change completion information, and then request, to the DBMS, new data which is a result of changing the existing data according to the data processing request information in the change target table and receive the new data from the DBMS, and match and store the new data with the change notification information stored in the storage unit 120.

In this case, the new data may include one or more column-specific new set values matched with the identifier corresponding to the data processing request information, and the existing data may include one or more column-specific existing set values matched with the identifier corresponding to the data processing request information.

Further, the data processing unit 131 may compare, when the existing data corresponding to the new data is present in the storage unit 120, the new data with the existing data for each of one or more columns constituting the change target table to remove the duplicated data and identify each of one or more columns of which set values are changed among the plurality of columns as the interested column (S2 and S3).

In this case, the data processing unit 131 may identify the existing data corresponding to (matched) with the new data based on the change notification information stored in the storage unit 120.

Further, the data processing unit 131 may generate one or more column information corresponding to one or more columns, respectively, and may not generate the column information without a removal process of the duplicated data when there the existing data corresponding to the new data is not present (S2).

In this case, the column information generated by the data processing unit 131 may include a column item of the column and an existing set value of the column corresponding to the interested column.

Further, when optimization for generating the log information for the changed data as described above is completed (S4), the data processing unit 131 generates SQL data for generating column information for each of one or more interested columns corresponding to data changed according to the data processing request information, and the log information including an identifier corresponding to the changed data, an instruction type corresponding to the changed data, and a change time corresponding to the changed data in the DBMS, and storing the column information and the log information in the DBMS, and transmit the generated SQL data to the DBMS (S6).

In this case, the data processing unit 131 may generate the SQL data for generating and storing the log information based on the column information for each of the one or more interested columns corresponding to the data changed according to the data processing request information, the identifier corresponding to the changed data, the instruction type corresponding to the changed data, and the change time corresponding to the changed data.

Further, the data processing unit 131 may generate the SQL data so that another metadata including at least one of a DML type, a host, an IP address, and a module of a task is added to the log information based on the change notification information (S5).

Further, the DBMS may generate the log information corresponding to the SQL data and store the log information in a log DB included in the DBMS when receiving the SQL data (S7).

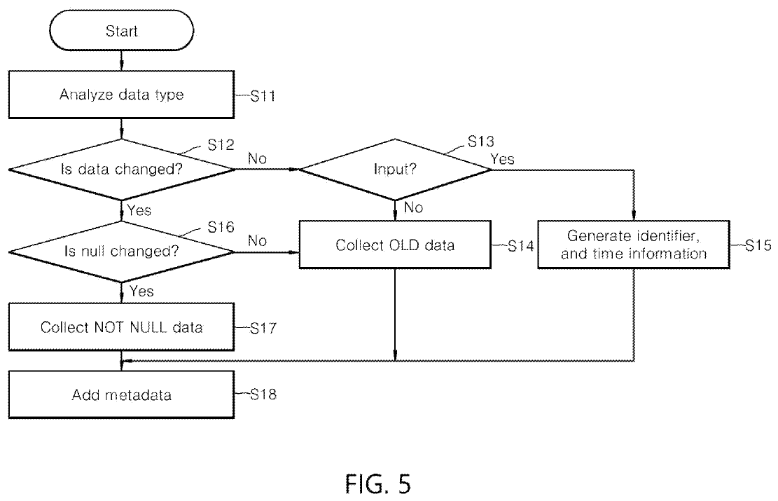

In the above-described configuration, when a log information optimization process through the removal of the duplicated data according to the data processing request information is described in more detail through FIG. 5, the data processing unit 131 analyzes data processing request information (S11), and when the instruction type corresponding to the changed data according to the data processing request information is ‘insert’ for data addition (S12 and S13), generates the SQL data for storing the log information including the identifier, the instruction type, and the change time corresponding to the changed data in the DBMS (S15), and when the instruction type corresponding to the changed data according to the data processing request information is ‘update’ (S12 and S13), generates SQL data so that only column information including a set value before the change for each interested column matched with the identifier corresponding to the changed data and having a changed set value is added to the log information and stored in the DBMS (S14), and when the instruction type corresponding to the changed data according to the data processing request information is ‘delete’ for data deletion (S12 and S16), only column information including a set value (not null) before the change for each interested column matched with the identifier corresponding to the changed data among one or more columns constituting the change target table and having a changed set value is added to the log information and stored in the DBMS (S14 or S17) to minimize the size of the log information stored in the DBMS.

In this case, the data processing unit 131 may generate the SQL data so that another metadata including at least one of a DML type, a host, an IP address, and a module of a task is added to the log information based on the change notification information (S18).

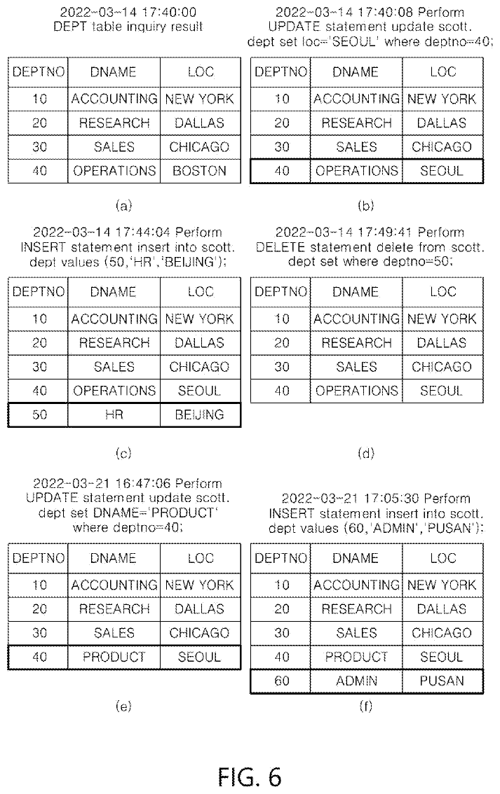

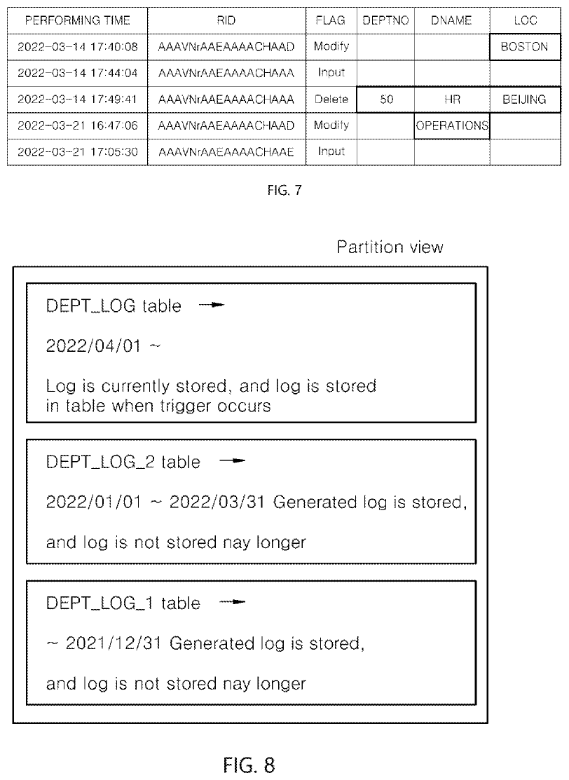

When an operation example of the data processing unit 131 is described in more detail with reference to FIGS. 6 and 7, if first data processing request information for changing (updating) ‘BOSTON’ which is a set value set in column ‘LOC’ matched with ‘40’ which is a set value of column ‘DEPTNO’ to ‘SEOUL’ is received by the DBMS as illustrated in FIG. 6B in an initial change target table (a change target table at a current time point) as illustrated in FIG. 6A, the data processing unit 131 may generate SQL data for storing column information including ‘LOC’ which is a column item of a column of which a set value is changed based on change notification information and change completion information corresponding to the first data processing request information, and ‘BOSTON’ which is an existing set value corresponding to the corresponding column item, and log information ‘update’ which is the instruction type corresponding to the first data processing request information, and an identifier (RID) corresponding to the first data processing request information and an execution time (change time) corresponding to the first data processing request information in the DBMS, and storing the column information and the log information in the DBMS, and transmit the SQL data to the DBMS as illustrated in FIG. 7.

Further, as illustrated in FIG. 6C, when second data processing request information for adding ‘50’, ‘HR’, and ‘BEIJING’ which are a plurality of set values corresponding to columns ‘DEPTNO’, ‘DNAME’, and ‘LOC’, respectively to the change target table is received by the DBMS, the data processing unit 131 may generate SQL data for generating log information including ‘input’ which is an instruction type corresponding to the second data processing request information, and an identifier (RID) corresponding to the second data processing request information and an execution time (change time) corresponding to the second data processing request information, and storing the log information in the DBMS based on the change notification information and the change completion information corresponding to the second data processing request information, and transmit the SQL data to the DBMS as illustrated in FIG. 7.

In this case, when the instruction type according to the second data processing request information is ‘input’, since the existing data matched with the identifier generated in the DBMS is not present in the change target table according to the second data processing request information, the data processing unit 131 may generate SQL data for generating log information without column information and storing the log information in the DBMS, and transmit the SQL data to the DBMS.

When third data processing request information for deleting a set value for each column matched with ‘50’ which is the set value of column ‘DEPTNO’ is received by the DBMS as illustrated in FIG. 6D, the data processing unit 131 may generate SQL data for storing column information including columns ‘DEPTNO’, ‘DNAME’, and ‘LOC’, which are a plurality of column-specific column items of which set values are changed based on the change notification information and the change completion information corresponding to the third data processing request information, and ‘50’, ‘HR’, and ‘BEIJING’ which are a plurality of existing set values corresponding to the plurality of column items, respectively, and log information including ‘delete’ which is an instruction type corresponding to the third data processing request information, and an identifier (RID) corresponding to the third data processing request information, and an execution time (change time) corresponding to the third data processing request information in the DBMS, and storing the column information and the log information in the DBMS, and transmit the SQL data to the DBMS, as illustrated in FIG. 7.

Further, the data processing unit 131 may allow the log information to be stored in the log DB of the DBMS by the scheme even with respect to fourth data processing request information and fifth data processing request information corresponding to FIGS. 6E and 6F, respectively.

That is, the data processing unit 131 may generate SQL data for generating log information from which set values corresponding to the remaining columns other than the interested column among the column-specific set values corresponding to the changed data are deleted, and storing the generated log information in the DBMS, and transmit the SQL data to the DBMS.

Through the above-described configuration, the data processing unit 131 supports to transmit SQL to decompose changed data when changing data for the change target table stored in the database at a column level and remove duplicated data, and generate and store log information constituted only by data required for recovery in the DBMS, and to store log information having a minimized size in the DBMS, and as a result, resource use (management) efficiency of the DBMS may be significantly increased, and recovery efficiency may also be significantly improved at the time of recovering the database to a specific time point based on the log information afterwards.

Meanwhile, as illustrated in FIG. 8, the log information management unit 132 may collect the log information stored in the log DB of the DBMS, and store the collected log information in the storage unit 120.

In this case, the log information management unit 132 may generates a log table by the unit of a predetermined period, and add the log table to a partition view including one or more log tables prestored in the storage unit 120, and partition and store, and manage the collected log information in different log tables partitioned by the unit of the predetermined period by a user.

As an example, the log information management unit 132 may transmit SQL based request information for requesting the log information stored in the log DB to the DBMS by accessing the DBMS periodically or in real time, and receive the log information from the DBMS and store the received log information in the partition view stored in the storage unit 120.

In this case, the log information management unit 132 sets a storage cycle and a partition reference of the log information according to a partition policy predetermined according to the user input through the input unit 140 in order to a large-capacity log to thereby partition and generate the log table storing the log information.

That is, the log information management unit 132 may generate a plurality of log tables in which different periods are set in the partition view while generating the log table by the unit of the predetermined period and adding the generated log table to the partition view stored in the storage unit 120, and add and store the log information to and in a log table corresponding to the change time according to the log information among the plurality of log tables included in the partition view.

Through this, the log information management unit 132 may delete data (log information) of which storage period is reached and reduce the log information stored in the storage unit 120, and delete the partitioned log table for managing the log information to be deleted from the partition view and avoid a performance penalty generated when the deleting the log information, thereby dramatically reducing a load and guaranteeing a high performance. Since the removed log information does not implement only the snapshot at the corresponding previous time point, the removed log information does not influence snapshot implementation at a subsequent previous time point. That is, only a time point when the snapshot is possible is adjusted.

That is, the log information management unit 132 may manage the log information by the unit of the log table, and conveniently delete one or more log information of which storage period expires (the storage cycle of the log information arrives) only by deleting the log table according to a predetermined partition policy.

The partition policy may be prestored in the log information management unit 132 as policy information, and the partition policy may be set according to the user input.

Further, when a structure such as column addition, deletion, change, etc. of the log table collecting the log information is changed, the log information management unit 132 fundamentally blocks the structure change, or reflects the structure change to a post log table to guarantee log information collected before the structure change to be used even after the structure change.

Meanwhile, when receiving a flashback request for recovering the change target table to a specific time point, the data inquiry unit 133 may easily recover the change target table to a data storage state of the change target table at the specific time point based on the log information included in the partition view stored in the storage unit 120, and this will be described in detail with reference to FIG. 3 and the following drawings.

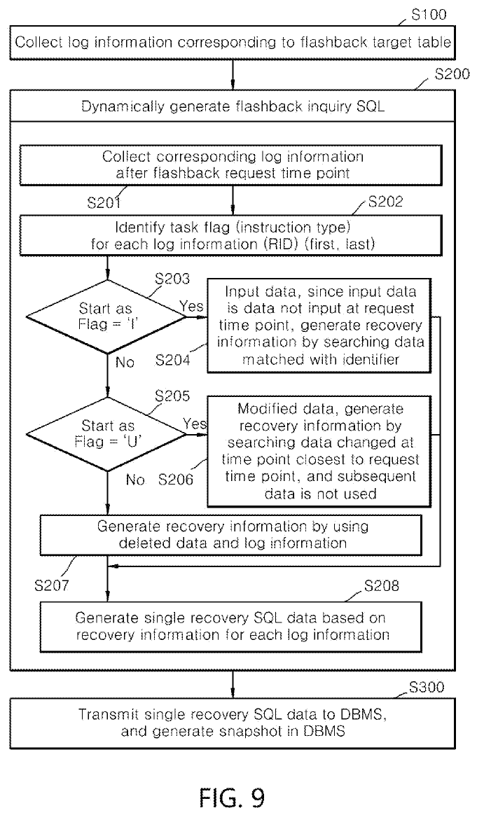

First, FIG. 9 is an operation flowchart of the data inquiry unit 133.

As illustrated, the data inquiry unit 133 may receive flashback request information for the flashback of recovering the change target table to the specific time point based on the user input through the input unit 140.

Further, the data inquiry unit 133 may identify the specific time point according to the flashback request information, and extract one or more log tables corresponding to an interested period which is a period between the specific time point and a current time point from the storage unit 120.

In this case, when there is a plurality of change target tables stored in the DBMS, the log information management unit 132 may generate a plurality of partition views corresponding to the plurality of change target tables and manage the log information for each change target table, and the data inquiry unit 133 may identify the change target table based on identification information of the change target table which is a recovery target included in the flash back request information, identify a partition view corresponding to the identified change target table based on the identification information, and then extract, from the storage unit 120, one or more log tables corresponding to the interested period from the identified partition view.

To this end, in the partition view, identification information of a change target table corresponding to the partition view may be set.

Further, the data inquiry unit 133 may collect one or more log information corresponding to the interested period in the one or more extracted log tables (S100).

Further, the data inquiry unit 133 may generate one or more recovery information based on the collected log information, and generate single recovery SQL datum for flashback inquiry based on the one or more recovery information (S200).

In this case, the data inquiry unit 133 may generate recovery information for adding or updating a set value for each interested column corresponding to the log information, or deleting a set value of the change target table corresponding to the identifier with an instruction type predetermined to be opposite to the instruction type according to the log information for each of the collected log information.

Here, the instruction type predetermined to be opposite to a specific instruction type may mean an instruction type for recovery (for a recovery purpose) matched with the specific instruction type, and predetermined to recover a result performed according to the specific instruction type to a state before performing. That is, the instruction type predetermined to be opposite to the specific instruction type may mean an instruction type capable of recovering the result performed according to the specific instruction type to the state before performing.

Further, the instruction type may include data addition (insert), data delete, and data update, and in the data inquiry unit 133, the data delete may be set as an instruction type opposite to the data insert, the data insert may be set as an instruction type opposite to the data delete, and the data update may be set as an instruction type opposite to the data update.

In this case, setting information for a plurality of different instruction types and opposite instruction types predetermined for each of the plurality of instruction types may be predetermined in the data inquiry unit 133.

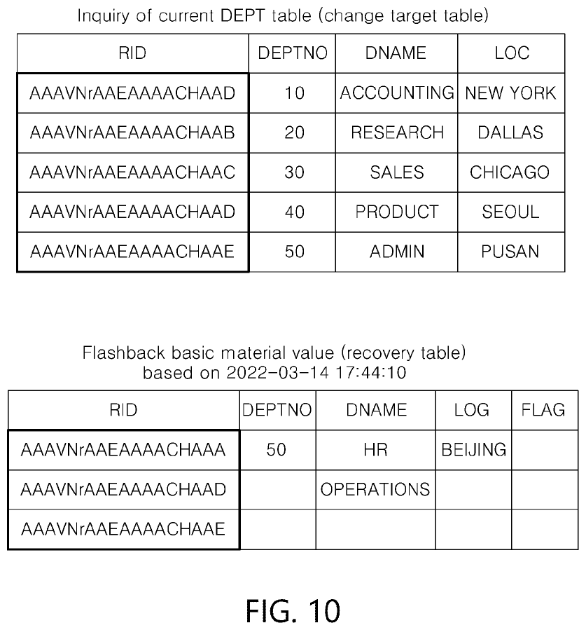

As an example, as illustrated in FIG. 10, when the data inquiry unit 133 receives the flashback request at a specific time point corresponding to 2022-03-14 17:44:10, the data inquiry unit 133 may extract one or more log tables which belong to an interested period between the specific time point and the current time point from the partition view stored in the storage unit 120, and collect one or more log information which belongs to the interested period in the one or more extracted log tables.

Further, if data corresponding to a first identifier ‘AAAVNrAAEAAAACEAAA’ according to first log information among the one or more collected log information is deleted from the change target table at 2022-03-14 17:49:41, a column-specific set value according to the first log information in the change target table at the specific time point should be input into the change target table again, and as a result, the data inquiry unit 133 may generate recovery information including the ‘data insert’ which is the instruction type predetermined to be opposite to the ‘data delete’ which is the instruction type according to the first log information, and the column-specific column information included in the first log information, and the change time and the first identifier.

Further, if with respect to data corresponding to a second identifier ‘AAAVNrAAEAAAACHAAD’ according to second log information among the one or more collected log information, ‘OPERATIONS’ which is the existing set value corresponding to column ‘DNAME’ is updated to a new set value in the change target table at 2022-03-21 16:47:06, a set value corresponding to the second identifier among the set values matched with column ‘DNMAE’ in the change target table at the specific time point should be updated to the existing set value according to the second log information, and as a result, the data inquiry unit 133 may generate recovery information including the ‘data update’ which is the instruction type predetermined to be opposite to the ‘data update’ which is the instruction type according to the second log information, and the change time and the column-specific column information according to the second log information, and the second identifier.

Further, if data corresponding to a third identifier ‘AAAVNrAAEAAAACHAAE’ according to third log information among the one or more collected log information is inserted into the change target table at 2022-03-21 17:05:30, a column-specific set value according to the third log information in the change target table at the specific time point should be deleted from the change target table again, and as a result, the data inquiry unit 133 may generate recovery information including the ‘data delete’ which is the instruction type predetermined to be opposite to the ‘data insert’ which is the instruction type according to the third log information, and the change time according to the third log information, and the third identifier.

In this case, the data inquiry unit 133 may delete the column-specific set value matched with the third identifier from the change target table only with the third identifier at the time of generating the recovery information including the instruction type for the data delete, and since the third log information does not include column-specific column information, recovery information without the column-specific column information may be generated.

As such, the data inquiry unit 133 may generate the recovery information for each of the one or more collected log information.

Further, the data inquiry unit 133 may generate the single recovery SQL data based on the recovery information generated for each collected log information.

As an example, the data inquiry unit 133 may generate a recovery table including one or more recovery information in which the recovery information generated for each collected log information is arranged in a time order, and generate single SQL data for recovering the change target table to the change target table at the specific time point according to the recovery table in the DBMS.

In this case, the data inquiry unit 133 may generate the single recovery SQL data to allow the DBMS to sequentially perform recovery (execution of the instruction type) according to the recovery information by starting from recovery information in which the change time is late (latest) based on the change time included in each recovery information.

In addition to the above configuration, an exemplary embodiment is described below that can increase the efficiency of the generation process of the single recovery SQL data.

First, the data inquiry unit 133 may identify and collect corresponding after a specific time point according to the flashback request (S201), and identify the instruction type included in the log information for each collected log information (S202).

Further, the data inquiry unit 133 may generate recovery information including an instruction type for deleting an identifier corresponding to log information for each log information in which the identified instruction type (flag) is data insert (or input) and data (a column-specific set value matched with the corresponding identifier) corresponding to the corresponding identifier from the change target table (S203 and S204).

Further, the data inquiry unit 133 may confirm an interested column for each log information in which the identified instruction type is data update (or modify), and collect only set values of interested columns included in log information most adjacent to the specific time point for each confirmed interested column to generate the recovery information (S205 and S206).

In this case, the collected set values of the interested column are not values other than a null value.

That is, the data inquiry unit 133 may confirm the interested column for each log information in which the identified instruction type is the data update (or modify), and extract a set value of the corresponding interested column from log information having the set value of the corresponding column other than the null value while possessing a change time most adjacent to a recovery time point according to the flashback request, and generate one recovery information including the column information for each interested column based on the set value extracted for each confirmed interested column.

As an example, when, in a state in which there is a plurality of log information in which the instruction type for ‘data update’ is set, first log information among the plurality of log information the instruction type for the corresponding ‘data update’ is set is matched with the first identifier and ‘NEY YORK’ is set as a set value of an interested column corresponding to ‘LOC’, and first log information among the plurality of log information is matched with the first identifier, and ‘SEOUL’ is set as the set value of the interested column corresponding to ‘LOC’, the change time according to the second log information is closer to the specific time point than the change time according to the first log information, the data inquiry unit 133 may calculate recovery information including ‘SEOUL’ other than ‘NEY YORK’ as the set value of the interested column corresponding to ‘LOC’ as recovery information corresponding to the first and second log information.

Further, when, in a state in which the first log information of the first and second log information among the plurality of log information is matched with the second identifier and ‘ACCOUNTING’ is set as a set value of an interested column corresponding to ‘DNAME’, and third log information further included in the plurality of log information is matched with the second identifier, and ‘OPERATIONS’ is set as the set value of the interested column corresponding to ‘DNAME’, the change time according to the third log information is closer to the specific time point than the change time according to the first log information, the data inquiry unit 133 may calculate recovery information corresponding to the plurality of log information so that only ‘OPERATIONS’ other than ‘ACCOUNTING’ is included as the set value of the interested column corresponding to ‘DNAME’.

That is, the data inquiry unit 133 may generate one recovery information generate by collecting only the set value for each interested column most close to the specific time point with respect to a plurality of log information related to data update, and reduce a processing load for data recovery of the DBMS through the generated recovery information.

Further, the data inquiry unit 133 may generate recovery information in which the set value for each interested column according to the log information is added to the change target table for each log information in which the identified instruction type is data delete (S207).

As a result, the data inquiry unit 133 may generate the single recovery SQL data based on one or more recovery information generated to correspond to one or more log information collected as described above (S208).

Further, the data inquiry unit 133 may transmit the single recovery SQL data to the DBMS.

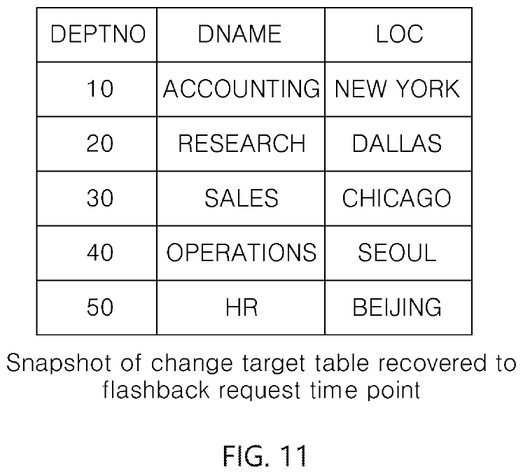

As a result, the DBMS may process a current change target table and recover the processed change target table to the change target table at the specific time point as illustrated in FIG. 11, and generate a snapshot including the recovered change target table according to the single recovery SQL data generated based on the recovery table illustrated in FIG. 10 (S300).

As an example, the DBMS may conserve set values of all columns because identifiers ‘AAAVNrAAEAAAACHAAA’, ‘AAAVNrAAEAAAACHAAB’, and ‘AAAVNrAAEAAAACHAAC’ are not present in the recovery table in the change target table according to the single recovery SQL data, conserve the remaining column value while replacing the set value of column ‘DNAME’ matched with the corresponding identifier ‘AAAVNrAAEAAAACHAAD’ with ‘OPERATIONS’ in the change target table because the instruction type set in the recovery table is data update (modify), delete the column-specific set value matched with the corresponding identifier ‘AAAVNrAAEAAAACHAAE’ because the instruction type set in the recovery table is data delete, and input all column-specific set values matched with the identifier ‘AAAVNrAAEAAAACEAAA’ into the change target table because the instruction type set in the recovery table is data input to recovery the change target table.

In this case, the DBMS may generate the recovered change target table by conserving data which is not changed in the change target table as it is by the single recovery SQL data.

Further, the data inquiry unit 133 may receive the snapshot (snapshot information) corresponding to the single recovery SQL data from the DBMS, and displays the corresponding snapshot through the display unit 150 of the user equipment 100 to provide a change target table at a specific time point set by the user to be confirmed.

According to the above configuration, the data inquiry unit 133 generates one or more recovery information for recovering the change target table to the specific time point based on one or more log information collected during an interested period between a specific time point when the user desires flashback of the change target table and a current time point, and generates single recovery SQL data for enabling the DBMS to process the one or more recovery information with one SQL datum and transmits the generated single recovery SQL data to the DBMS to easily recover the change target table to a state at the specific time point with the single SQL data in the DBMS, and as a result, it is possible to prevent a problem in that the user equipment 100 transmits recovery information to the DBMS for each of the plurality of log information and an operation load of the DBMS thus increases.

As described above, according to the present disclosure, a UNDO record at each time point for recovering to a specific time point for a database is not kept, and data is decomposed at a column level and log information from which duplication of data is removed is stored in a DBMS, so in an environment in which a lot of data change histories are generated and a database requiring searching data at a previous time point is required, a minimum change history is managed and stored and a disk space required for storing a changed record can be significantly reduced, and as a result, cost can be reduced and a processing speed can be also improved, and recovered information is easily generated based on one or more log information collected between a specific time point when a user desires flashback and a current time point to support the recovery to be made based thereon and support one or more recovered information to be enabled to be processed with one SQL datum, thereby significantly reducing a processing load of a DBMS and simultaneously significantly increasing processing efficiency of the DBMS for database recovery.

Further, according to the present disclosure, metadata such as an identifier is used while the data change history is managed to reduce a size of execution history information, and a log information amount for a complete snapshot is significantly reduced without information loss while not influencing a processing speed.

Moreover, according to the present disclosure, a change history is managed by the unit of a specific table, and a long-term change history is supported to be managed from a desired time point through partition view based partition management for the log data.

Besides, according to the present disclosure, when the change history, and the snapshot at the specific time point are required, the change history and the snapshot are generated and provided by using the change history, and a time according to unnecessary data processing is reduced through condition search and table-specific search so that the user may inquire only required data in this process, and optimized data is provided to the user.

The components described in the exemplary embodiments of the present disclosure may be implemented by using, for example, hardware such as a storage unit such as a memory, a processor, a controller, an arithmetic logic unit (ALU), a digital signal processor, a microcomputer, a field programmable gate array (FPGA), a programmable logic unit (PLU), a microprocessor, etc., software including an instruction set or a combination thereof or one or more universal computers or specific-purpose computers like any other devices which may execute and respond to an instruction.

The aforementioned contents can be corrected and modified by those skilled in the art without departing from the essential characteristics of the present disclosure. Therefore, the exemplary embodiments of the present disclosure are provided for illustrative purposes only but not intended to limit the technical concept of the present disclosure. The scope of the technical concept of the present disclosure is not limited to the exemplary embodiment. The protective scope of the present disclosure should be construed based on the following claims, and all the technical concepts in the equivalent scope thereof should be construed as falling within the scope of the present disclosure.

What is claimed is:

1. A user equipment which interlocks with a DBMS, the user equipment comprising:
a data processing unit configured to store SQL data for storing, when the data stored in the DBMS is changed, the data in the DBMS, and generate, in the DBMS, column information on an interested column of which set value is changed among one or more columns constituting a change target table which stores the changed data, and log information including identifier and instruction types corresponding to the changed data and a change time, and store the log information in the DBMS, and transmit the SQL data to the DBMS;
a log information management unit configured to collect log information stored in a log DB of the DBMS, and partition and manage the collected log information to different log tables by the unit of a predetermined period; and
a data inquiry unit configured to collect, when receiving a flashback request for recovering the change target table to a specific time point, from one or more log tables corresponding to an interested period between the specific time point and a current time point, generate one or more recovery information based on the collected log information, and then generate single recovery SQL data based on the one or more recovery information, and transmitting the single recovery SQL data to the DBMS to allow the DBMS to generate a snapshot corresponding to the specific time point based on the single recovery SQL data.

2. The user equipment of claim 1, wherein the data processing unit generates SQL data for storing, in the log DB of the DBMS, log information selectively including the column information including a column item for each of one or more interested columns among one or more columns constituting the change target table and a set value before a change according to the instruction type, and including an identifier allocated by the DBMS corresponding to the changed data, and an instruction type and a change time used for the change of the data in the log DB of the DBMS, and transmits the generated SQL data to the DBMS.

3. The user equipment of claim 2, wherein when the instruction type according to the data change for the change target table is data add, the data processing unit generates SQL data for generating log information including the identifier, the instruction type, and the change time, and transmits the generated SQL data to the DBMS.

4. The user equipment of claim 1, wherein the data processing unit generates SQL data for generating log information from which set values corresponding to the remaining columns other than the interested column among the column-specific set values corresponding to the changed data are deleted, and transmits the SQL data to the DBMS.

5. The user equipment of claim 1, wherein the log information management unit deletes a log table corresponding to log information of which storage cycle arrives among the plurality of log tables according to a storage cycle of the log information predetermined according to a user input.

6. The user equipment of claim 1, wherein the data inquiry unit generates recovery information for adding or updating a set value for each interested column corresponding to the log information, or deleting a set value of the change target table corresponding to the identifier with an instruction type predetermined to be opposite to the instruction type according to the log information for each of the collected log information, and then generates the single recovery SQL data based on the recovery information generated for each collected log information.

7. The user equipment of claim 6, wherein the instruction type may include data addition, data delete, and data update, and in the data inquiry unit, the data delete is set as an instruction type opposite to the data insert, the data insert is set as an instruction type opposite to the data delete, and the data update is set as an instruction type opposite to the data update.

8. The user equipment of claim 1, wherein the data inquiry unit identifies the instruction type included in the log information for each collected log information, generates recovery information including an identifier according to log information for each log information in which the identified instruction type is the data addition an instruction type for deleting a column-specific set value matched with the corresponding identifier from the change target table confirms an interested column for each of one or more log information in which the identified instruction type is the data update and collects only set values of interested columns included in log information most adjacent to the specific time point for each confirmed interested column to generate one recovery information corresponding to one or more log information, generates recovery information in which the interested-column set value according to the log information is added to the change target table for each log information in which the identified instruction type is the data delete, and generates the single recovery SQL data based on one or more recovery information generated to correspond to the one or more collected log information.

9. An operating method for flashback of a database of a user equipment which interlocks with a DBMS, the operating method comprising:
generating SQL data for storing, when the data stored in the DBMS is changed, the data in the DBMS, and generating, in the DBMS, column information on an interested column of which set value is changed among one or more columns constituting a change target table which stores the changed data, and log information including identifier and instruction types corresponding to the changed data and a change time, and storing the log information in the DBMS, and transmitting the SQL data to the DBMS;
collecting log information stored in a log DB of the DBMS, and partitioning and managing the collected log information to different log tables by the unit of a predetermined period by a user; and
collecting, when receiving a flashback request for recovering the change target table to a specific time point, from one or more log tables corresponding to an interested period between the specific time point and a current time point, generating one or more recovery information based on the collected log information, and then generating single recovery SQL data based on the one or more recovery information, and transmitting the single recovery SQL data to the DBMS to allow the DBMS to generate a snapshot corresponding to the specific time point based on the single recovery SQL data.

10. The operating method of claim 9, wherein the generating of the snapshot further includes generating recovery information for adding or updating a set value for each interested column corresponding to the log information, or deleting a set value of the change target table corresponding to the identifier with an instruction type predetermined to be opposite to the instruction type according to the log information for each of the collected log information, and then generating the single recovery SQL data based on the recovery information generated for each collected log information.
